(19) United States
(12) Patent Application Publication
(10) Pub. No.: US 2017/0018828 A1
(43) Pub. Date: Jan. 19, 2017

(54) ELECTROLYTE FOR METAL-AIR BATTERIES, AND METAL-AIR BATTERY

(71) Applicant: TOYOTA JIDOSHA KABUSHIKI KAISHA, Toyota-shi (JP)

(72) Inventor: Hiroshi SUYAMA, Mishima-shi (JP)

(73) Assignee: TOYOTA JIDOSHA KABUSHIKI KAISHA, Toyota-shi (JP)

(21) Appl. No.: 15/195,423

(22) Filed: Jun. 28, 2016

(30) Foreign Application Priority Data
Jul. 13, 2015 (JP) 2015-140053

(51) Int. Cl. H01M 12/08; H01M 8/08; H01M 4/38

(52) U.S. Cl. CPC H01M 12/08; H01M 4/38; H01M 8/08; H01M 2300/0002

(57) ABSTRACT

An electrolyte for metal-air batteries, which is able to inhibit the coarsening of a discharge product that is produced upon the discharge of metal-air batteries, and a metal-air battery using the electrolyte. The electrolyte may comprise an aqueous solution that contains an inhibitor of the coarsening of a discharge product, the inhibitor containing a salt that contains at least one kind of anions selected from the group consisting of S²⁻ anions, SCN⁻ anions and S₂O₃²⁻ anions.

This application claims priority to Japanese Patent Application No. 2015-140053, filed Jul. 13, 2015. The entire contents of the prior application are hereby incorporated by reference herein in their entirety.

### TECHNICAL FIELD

The disclosure relates to an electrolyte for metal-air batteries, and a metal-air battery.

### BACKGROUND

An air battery in which oxygen is used as an active material, has many advantages such as high energy density. Well-known examples of air batteries include metal-air batteries such as an aluminum-air battery and a magnesium-air battery.

As a technique relating to such air batteries, an aluminum-air battery including a cathode (air electrode), an electrolyte and an anode in which an aluminum metal is used, is disclosed in Patent Literatures 1 and 2, for example.

Patent Literature 1: Japanese Patent Application Laid-Open (JP-A) No. 2014-139878

Patent Literature 2: JP-A No. 2012-028017

However, metal-air batteries in which a metal such as aluminum or magnesium is used in the anode, is problematic in that a discharge product such as aluminum hydroxide and magnesium hydroxide is produced upon discharge, deposits on the anode surface, and becomes non-electroconductive, thereby inhibiting the discharge of the batteries.

In addition, by the use of the above-mentioned conventional metal-air batteries, there is such a problem that the discharge product is coarsened on the anode surface and is not easily removed in the case of, for example, removing the discharge product from the anode surface by an electrolyte flow.

### SUMMARY

The disclosed embodiments were achieved in light of the above circumstance. An object of the disclosed embodiments is to provide an electrolyte for metal-air batteries, which is able to inhibit the coarsening of the discharge product produced upon the discharge of metal-air batteries, and a metal-air battery using the electrolyte.

In a first embodiment, there is provided an electrolyte for metal-air batteries having an anode containing at least one of aluminum and magnesium. The electrolyte comprises an aqueous solution comprising a coarsening inhibitor configured to inhibit coarsening of a discharge product, the coarsening inhibitor including a salt having at least one kind of anions selected from the group consisting of S²⁻ anions, SCN⁻ anions and S₂O₃²⁻ anions.

The coarsening inhibitor may be at least one selected from the group consisting of Na₂S, NaSCN and Na₂S₂O₃. A concentration of the coarsening inhibitor in the aqueous solution may be in a ra nge of 0.001 mol/L or more to 0.1 mol/L or less.

The aqueous solution may be basic. The aqueous solution may include an electrolyte salt. The electrolyte salt may be NaOH. A concentration of the electrolyte salt in the aqueous solution may be in a range of 0.01 mol/L or more to 20 mol/L or less.

In another embodiment, there is provided a metal-air battery comprising an air electrode configured to receive an oxygen supply, an anode containing at least one of aluminum and magnesium and an electrolyte as set forth above, the electrolyte being in contact with the air electrode and the anode.

The metal-air battery may further comprise a separator disposed between the air electrode and the anode, the separator configured to retain the electrolyte. The separator may be porous. The porosity of the separator may be in a range of 30% to 90%. A thickness of the separator may be in a range of 0.1 to 100 μm.

A thickness of the air electrode may be in a range of 2 μm to 500 μm.

The aluminum is an aluminum metal containing impurities, and an element ratio of the aluminum in the aluminum metal is in a range of 50% or more to 99.99% or less.

The aluminum is an aluminum alloy, and a content of the aluminum in the aluminum alloy is 50% by mass or more.

According to the disclosed embodiments, the coarsening of the discharge product produced upon the discharge of metal-air batteries, can be inhibited. As a result, the discharge product can be easily removed from the anode surface of metal-air batteries.

### BRIEF DESCRIPTION OF THE DRAWINGS

FIG. 1 is a sectional view of a schematic configuration of the metal-air battery according to an embodiment;

FIG. 2 shows images of the appearance of aluminum plates dissolved using the electrolytes of Examples 1 to 3 and Comparative Examples 1 to 8; and

FIG. 3 is a graph comparing the discharge curve of the case where Na₂S₂O₃ was used, with that of the case where Na₂S₂O₃ was not used.

### DETAILED DESCRIPTION

### 1. Electrolyte for Metal-Air Batteries

The electrolyte for metal-air batteries according to the disclosed embodiments is an electrolyte for metal-air batteries, batteries having an anode containing at least one of aluminum and magnesium, the electrolyte comprising an aqueous solution comprising a coarsening inhibitor configured to inhibit coarsening of a discharge product, the coarsening inhibitor including a salt having at least one kind of anions selected from the group consisting of S²⁻ anions, SCN⁻ anions and S₂O₃²⁻ anions.

A metal-air battery including an anode that contains at least one of aluminum and magnesium, is problematic in that even if the amount of the electrolyte is sufficient to dissolve the aluminum or magnesium, a discharge product is deposited on the anode surface by discharge and coarsened when the purity of the aluminum or magnesium is less than 99.999%.

Meanwhile, in the case of using a high-purity metal, it is problematic in that there is an increase in cost and makes practical application difficult.

Without intending to be bound by theory, it is considered that the reason for the coarsening of the discharge product is because the impurities which are present in the anode metal, such as iron, silicon, zinc, manganese, zirconium, copper, nickel, titanium or chromium, serves as the core of the discharge product deposited on the anode surface.

It was found that the coarsening of the discharge product can be inhibited by adding the coarsening inhibitor to the electrolyte. Without intending to be bound by theory, it is considered that this is because anions contained in the coarsening inhibitor that is added to the electrolyte, form complexes with the impurities such as iron, so that the coarsening of the discharge product resulting from the impurities can be inhibited.

Also, it was found that the self-discharge of the metal-air battery can be inhibited by adding the coarsening inhibitor to the electrolyte. The self-discharge reaction of the metal-air battery is caused when a local cell is formed due to a potential difference between the main element (Al, Mg) of the metal contained in the anode (hereinafter it may be referred to as anode metal) and impurity elements (e.g., iron) contained in the metal. For example, in the case where the main element of the metal is aluminum, or iron, which is one of the impurities, serves as the cathode. In the cathode, a reductive decomposition reaction of water is developed on the iron surface. In the anode, an oxidation reaction of the aluminum (that is, an elution reaction induced by ionization) is developed.

According to the electrolyte of the disclosed embodiments, it is considered that the anions contained in the coarsening inhibitor form complexes with the impurities such as iron, so that the iron, which is in a solid state, can be quickly eluted into the electrolyte. As a result, it is considered that the local cell formation is inhibited, so that the self-discharge of the metal-air battery can be inhibited.

The anions contained in the coarsening inhibitor are preferably sulfur-based, thiocyanic acid-based and/or sulfur oxide-based anions. More specifically, they are preferably at least one kind of anions selected from S²⁻, SCN⁻ and S₂O₃²⁻.

Cations are contained in the coarsening inhibitor. As the cations, at least one kind of cations selected from the group consisting of Li, K, Na, Rb, Cs, Fr, Mg, Ca, Sr, Ba and Ra are preferred. Of them, K⁺ and Na⁺ are more preferred. The cations are those of a metal that is electrochemically baser than aluminum and magnesium. Accordingly, in the electrolyte, the cations are less reactive with aluminum and magnesium, which serve as anode metals in the electrolyte. Therefore, it is considered that the cations are less likely to disrupt a complex-forming reaction of the anions with the impurities (such as iron) contained in the anode metal, the reaction being directed toward the inhibition of the coarsening.

Concrete examples of the coarsening inhibitor include Na₂S, Na₂S₂O₃ and NaSCN.

The content of the coarsening inhibitor in the electrolyte is not particularly limited. It is preferably in a range of 0.001 mol/L or more and 0.1 mol/L or less.

The electrolyte salt is not particularly limited, as long as it is soluble in water and can offer desired ion conductivity. The electrolyte salt is preferably one that is able to make the electrolyte neutral or basic. From the viewpoint of increasing electrode reactivity, it is particularly preferably one that is able to make the electrolyte basic.

The electrolyte salt is preferably one that contains at least one kind of metal selected from the group consisting of Li, K, Na, Rb, Cs, Fr, Mg, Ca, Sr, Ba and Ra. Examples of the electrolyte salt include, but are not limited to, LiCl, NaCl, KCl, MgCl₂, CaCl₂, LiOH, KOH, NaOH, RbOH, CsOH, Mg(OH)₂, Ca(OH)₂ and Sr(OH)₂. Of them, preferred are NaOH and KOH. Particularly preferred is NaOH.

The concentration of the electrolyte salt is not particularly limited. The lower limit is preferably 0.01 mol/L or more, more preferably 0.1 mol/L or more, and still more preferably 1 mol/L or more. The upper limit is preferably 20 mol/L or less, more preferably 10 mol/L or less, and still more preferably 8 mol/L or less.

When the concentration of the electrolyte salt is less than 0.01 mol/L, the solubility of the anode metal may decrease. When the concentration of the electrolyte salt is more than 20 mol/L, the self-discharge of the metal-air battery is accelerated and may reduce battery characteristics.

The pH of the electrolyte is preferably 7 or more, more preferably 10 or more, and particularly preferably 14 or more.

### 2. Metal-Air Battery

The metal-air battery according to the disclosed embodiments is a metal-air battery comprising: an air electrode configured to receive an oxygen supply; an anode containing at least one of aluminum and magnesium; and an electrolyte as set forth above, the electrolyte being in contact with the air electrode and the anode.

In the disclosed embodiments, the metal-air battery is a battery in which a reduction reaction of oxygen, which is an active material, is carried out in the air electrode; an oxidation reaction of a metal is carried out in the anode; and ions are conducted by the electrolyte disposed between the air electrode and the anode. Examples of the type of the metal-air battery include a magnesium-air primary battery and an aluminum-air primary battery.

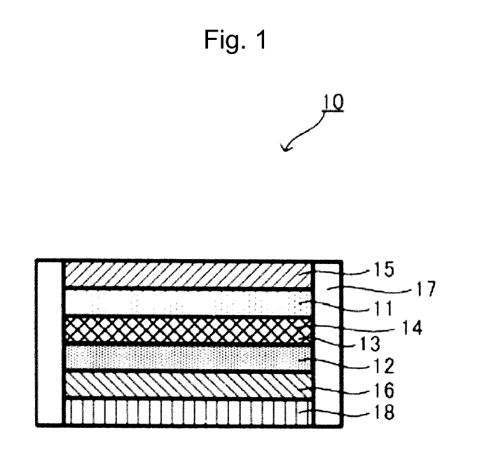

FIG. 1 is a sectional view of a schematic configuration of the metal-air battery according to the disclosed embodiments.

As shown in FIG. 1, a metal-air battery 10 includes an anode 11; an air electrode 12 disposed away from the anode 11; a separator 14 retaining an electrolyte 13 disposed between the anode 11 and the air electrode 12; an anode current collector 15 connected to the anode 11; an air electrode current collector 16 connected to the air electrode 12; and an outer case 17 housing these members. The outer case 17 is partly composed of a water repellent film 18. Using the water repellent film 18 and so on, the metal-air battery 10 is composed so that the electrolyte 13 does not leak from the outer case 17.

The electrolyte which is usable in the metal-air battery of the disclosed embodiments will not be described here since it is the same as the electrolyte described above under “1. Electrolyte for metal-air batteries”.

As needed, the metal-air battery of the disclosed embodiments has the separator for insulating the air electrode and the anode from each other. From the viewpoint of retaining the electrolyte, the separator preferably has a porous structure. The porous structure of the separator is not particularly limited, as long as it can retain the electrolyte. Examples include, but are not limited to, a mesh structure in which constituent fibers are regularly arranged, a non-woven fabric structure in which constituent fibers are randomly arranged, and a three-dimensional network structure which has separate holes and connected holes. As the separator, conventionally-known separators can be used. Examples include, but are not limited to, porous films made of polyethylene, polypropylene, polyethylene terephthalate, cellulose, etc., and non-woven fabrics such as a resin non-woven fabric and a glass fiber non-woven fabric.

The thickness of the separator is not particularly limited. For example, it is preferably in a range of 0.1 to 100 μm.

The porosity of the separator is preferably in a range of 30 to 90%, and more preferably in a range of 45 to 70%. When the porosity is too small, the separator has a tendency to disturb ion diffusion. When the porosity is too high, the strength of the separator has a tendency to decrease.

The air electrode contains at least an electroconductive material.

The electroconductive material is not particularly limited, as long as it has electroconductivity. Examples include, but are not limited to, a carbonaceous material, a perovskite-type electroconductive material, a porous electroconductive polymer, a metal body, etc.

The carbonaceous material can be a porous or non-porous carbonaceous material. Preferably, the carbonaceous material is a porous carbonaceous material. This is because it has a large specific surface area and can provide many reaction sites. Examples of the porous carbonaceous material include, but are not limited to, mesoporous carbon. Examples of the non-porous carbonaceous material include, but are not limited to, graphite, acetylene black, carbon black, carbon nanotubes and carbon fibers.

The metal body can be composed of a known metal that is stable to the electrolyte. More specifically, the metal body can be a metal body in which a metal layer (coating film) containing at least one kind of metal selected from the group consisting of, for example, Ni, Cr and Al is formed on the surface, or a metal body which is wholly composed of a metal material that is made of at least one kind of metal selected from the group consisting of Ni, Cr and Al. The form of the metal body can be a known form such as a metal mesh, a perforated metal foil or a foam metal.

The content of the electroconductive material in the air electrode is preferably in a range of 10 to 99% by mass, and particularly preferably in a range of 50 to 95% by mass, when the total mass of the air electrode is determined as 100% by mass, for example.

The air electrode can contain a catalyst that promotes electrode reactions. The catalyst can be carried on the electroconductive material.

As the catalyst, a known catalyst which has an oxygen reduction ability and is usable in metal-air batteries, can be appropriately used. For example, there may be mentioned at least one kind of metal selected from the group consisting of ruthenium, rhodium, palladium and platinum; a perovskite-type oxide containing a transition metal such as Co, Mn or Fe; a metal-coordinated organic compound having a porphyrin or phthalocyanine structure; an inorganic ceramic such as manganese dioxide (MnO₂) or cerium oxide (CeO₂); and a composite material made of a mixture of the above materials.

The content of the catalyst in the air electrode is preferably in a range of 0 to 90% by mass, and particularly preferably in a range of 1 to 90% by mass, when the total mass of the air electrode is determined as 100% by mass, for example.

As needed, the air electrode contains a binder for fixing the electroconductive material.

As the binder, there may be mentioned polyvinylidene fluoride (PVdF), polytetrafluoroethylene (PTFE), styrene-butadiene rubber (SBR), etc.

The content of the binder in the air electrode is not particularly limited. For example, it is preferably in a range of 1 to 40% by mass, and particularly preferably in a range of 10 to 30% by mass, when the total mass of the air electrode is determined as 100% by mass.

As the method for producing the air electrode, examples include, but are not limited to, a method for mixing the above-described air electrode materials (such as the electroconductive material) and roll-pressing the mixture, and a method for applying a slurry containing the above-described air electrode materials and a solvent. As the solvent used to prepare the slurry, examples include, but are not limited to, acetone, ethanol and N-methyl-2-pyrrolidone (NMP). As the method for applying the slurry, examples include, but are not limited to, a spraying method, a screen printing method, a gravure printing method, a die coating method, a doctor blade method, an inkjet method, etc. More specifically, the air electrode can be formed by applying the slurry to the below-described air electrode current collector or carrier film, drying the applied slurry, and then roll-pressing and cutting the dried slurry, as needed.

The thickness of the air electrode varies depending on the application of the metal-air battery, etc. For example, it is preferably in a range of 2 to 500 μm, and particularly preferably in a range of 30 to 300 μm.

As needed, the metal-air battery of the disclosed embodiments has the air electrode current collector that collects current from the air electrode. The air electrode current collector can be one having a porous structure or one having a dense structure, as long as it has a desired electron conductivity. From the viewpoint of air (oxygen) diffusivity, it is preferably one having a porous structure such as a mesh structure. As the form of the air electrode current collector, examples include, but are not limited to, a foil form, a plate form and a mesh (grid) form. The porosity of the current collector having the porous structure is not particularly limited. For example, it is preferably in a range of 20 to 99%.

As the material for the air electrode current collector, examples include, but are not limited to, stainless-steel, nickel, aluminum, iron, titanium, copper, gold, silver and palladium; carbonaceous materials such as carbon fiber and carbon paper; and highly electron conductive ceramic materials such as titanium nitride.

The thickness of the air electrode current collector is not particularly limited. For example, it is preferably in a range of 10 to 1000 μm, and particularly preferably in a range of 20 to 400 μm. The below-described outer case can also function as the air electrode current collector.

The air electrode current collector can have a terminal that serves as a connection to the outside.

The anode contains at least an anode active material.

As the anode active material, examples include, but are not limited to, an aluminum metal containing impurities, a magnesium metal containing impurities, an aluminum alloy, a magnesium alloy, an aluminum compound, a magnesium compound, etc. Of them, preferred is an aluminum metal containing impurities.

As the aluminum alloy, examples include, but are not limited to, an alloy of aluminum and a metal material selected from the group consisting of vanadium, silicon, magnesium, iron, zinc and lithium. The metal constituting the aluminum alloy (that is, the metal other than aluminum) can be one or more kinds of metals.

As the aluminum compound, examples include, but are not limited to, aluminum(III) nitrate, aluminum(III) chloride oxide, aluminum(III) oxalate, aluminum(III) bromide, and aluminum(III) iodide.

In the case where the anode is the aluminum metal containing impurities, the purity of the aluminum in the aluminum metal is not particularly limited. For the element ratio of the aluminum contained in the aluminum metal, the lower limit is preferably 50% or more, more preferably 80% or more, still more preferably 95% or more, and particularly preferably 99.5% or more. Also for the element ratio of the aluminum contained in the aluminum metal, the upper limit can be less than 99.999%, can be 99.99% or less, or can be 99.9% or less. In the aluminum metal, iron may be contained as one of the impurities. The element ratio of the iron contained in the aluminum metal is not particularly limited. It can be less than 0.001%, less than 0.01%, or less than 0.1%.

In the aluminum alloy, the content of the aluminum is preferably 50% by mass or more, when the total mass of the alloy is determined as 100% by mass.

The form of the anode is not particularly limited. Examples include, but are not limited to, a plate form, a rod form, a particulate form, etc. From the viewpoint of the form that can easily increase the performance of the metal-air battery, a particulate form is preferred. When the anode is in a particulate form, the lower limit of the diameter of the particles is preferably 1 nm or more, more preferably 10 nm or more, still more preferably 100 nm or more, and the upper limit of the diameter of the particles is preferably 100 mm or less, more preferably 10 mm or less, and still more preferably 1 mm or less.

In the disclosed embodiments, the average particle diameter of the particles is calculated by a general method. An example of the method for calculating the average particle diameter of the particles is as follows. First, for a particle shown in an image taken at an appropriate magnitude (e.g., 50,000× to 1,000,000×) with a transmission electron microscope (hereinafter referred to as TEM) or a scanning electron microscope (hereinafter referred to as SEM), the diameter is calculated on the assumption that the particle is spherical. Such a particle diameter calculation by TEM or SEM observation is carried out on 200 to 300 particles of the same type, and the average of the particles is determined as the average particle diameter.

As needed, the anode contains at least one of the electroconductive material and the binder for fixing the anode active material. For example, when the anode active material is in a plate form, the anode can be an anode that contains only the anode active material. On the other hand, when the anode active material is a powdery (particulate) form, the anode can be an anode that contains the anode active material and at least one of the electroconductive material and the binder, The type and amount of the electroconductive material used, the type and amount of the binder used, etc., can be the same as those of the air electrode described above.

As needed, the anode has the anode current collector that collects current from the anode. The material for the anode current collector is not particularly limited, as long as it is electroconductive. Examples include, but are not limited to, stainless-steel, nickel, copper and carbon. As the form of the anode current collector, examples include, but are not limited to, a foil form, a plate form, and a mesh form. The thickness of the anode current collector is not particularly limited. For example, it is preferably in a range of 10 to 1000 μm, and particularly preferably in a range of 20 to 400 μm. The below-described outer case can also function as the anode current collector.

The anode current collector can have a terminal that serves as a connection to the outside.

The metal-air battery of the disclosed embodiments generally has the outer case for housing the air electrode, the anode, the electrolyte, etc.

As the form of the outer case, examples include, but are not limited to, a coin form, a flat plate form, a cylindrical form and a laminate form.

The material for the outer case is not particularly limited, as long as it is stable to the electrolyte. Examples include, but are not limited to, a metal body that contains at least one kind of metal selected from the group consisting of Ni, Cr and Al, and a resin such as polypropylene, polyethylene or acrylic resin. In the case where the outer case is the metal body, the outer case can be such that only the surface is composed of the metal body, or such that the outer case is wholly composed of the metal body.

The outer body can be an open-to-the-atmosphere type or a hermetically-closed type. The open-to-the-atmosphere type outer case has an opening for taking in oxygen from the outside (i.e., an oxygen inlet) and has a structure that allows at least the air electrode to be in sufficient contact with the atmosphere. The oxygen inlet can be provided with an oxygen permeable film, water repellent film, etc. The hermetically-closed type battery case can have an oxygen (air) inlet tube and an outlet tube.

The water repellent film is not particularly limited, as long as it is made of a material that does not leak the electrolyte and allows the air to reach the air electrode. As the water repellent film, examples include, but are not limited to, a porous fluorine resin sheet (such as PTFE) and water-repellent, porous cellulose.

An oxygen-containing gas is supplied to the air electrode. As the oxygen-containing gas, examples include, but are not limited to, air, dry air, pure oxygen, etc. The oxygen-containing gas is preferably dry air or pure oxygen, and particularly preferably pure oxygen.

### EXAMPLES

### Example 1

First, an aqueous solution of 1 mol/L NaOH (manufactured by Kanto Chemical Co., Inc.) was prepared. The aqueous solution was kept in a thermostatic bath (product name: LU-113; manufactured by: ESPEC Corp.) at 25° C. for 8 hours. Then, as a coarsening inhibitor, Na₂S (manufactured by Aldrich) was added to the aqueous solution so as to be 0.01 mol/L. Next, the aqueous solution was stirred with an ultrasonic washing machine for 15 minutes, Then, the aqueous solution was kept in the thermostatic bath at 25° C. for 3 hours, thereby obtaining an electrolyte for metal-air batteries.

### Example 2

An electrolyte for metal-air batteries was produced in the same manner as Example 1, except that Na₂S was changed to Na₂S₂O₃ (manufactured by Aldrich).

### Example 3

An electrolyte for metal-air batteries was produced in the same manner as Example 1, except that Na₂S was changed to NaSCN (manufactured by Aldrich).

### Comparative Example 1

An electrolyte for metal-air batteries was produced in the same manner as Example 1, except that Na₂S was not added.

### Comparative Example 2

An electrolyte for metal-air batteries was produced in the same manner as Example 1, except that Na₂S was changed to NaHSO₃ (manufactured by Aldrich).

### Comparative Example 3

An electrolyte for metal-air batteries was produced in the same manner as Example 1, except that Na₂S was changed to NaHSO₄ (manufactured by Aldrich).

### Comparative Example 4

An electrolyte for metal-air batteries was produced in the same manner as Example 1, except that Na₂S was changed to Na₂SO₄ (manufactured by Aldrich).

### Comparative Example 5

An electrolyte for metal-air batteries was produced in the same manner as Example 1, except that Na₂S was changed to Na₂S₂O₅ (manufactured by Aldrich).

### Comparative Example 6

An electrolyte for metal-air batteries was produced in the same manner as Example 1, except that Na₂S was changed to Na₂S₂O₇ (manufactured by Aldrich).

### Comparative Example 7

An electrolyte for metal-air batteries was produced in the same manner as Example 1, except that Na₂S was changed to Na₂S₂O₈ (manufactured by Aldrich).

### Comparative Example 8

An electrolyte for metal-air batteries was produced in the same manner as Example 1, except that Na₂S was changed to Na₂H₂P₂O₇ (manufactured by Aldrich).

### [Observation of the Form of Discharge Products]

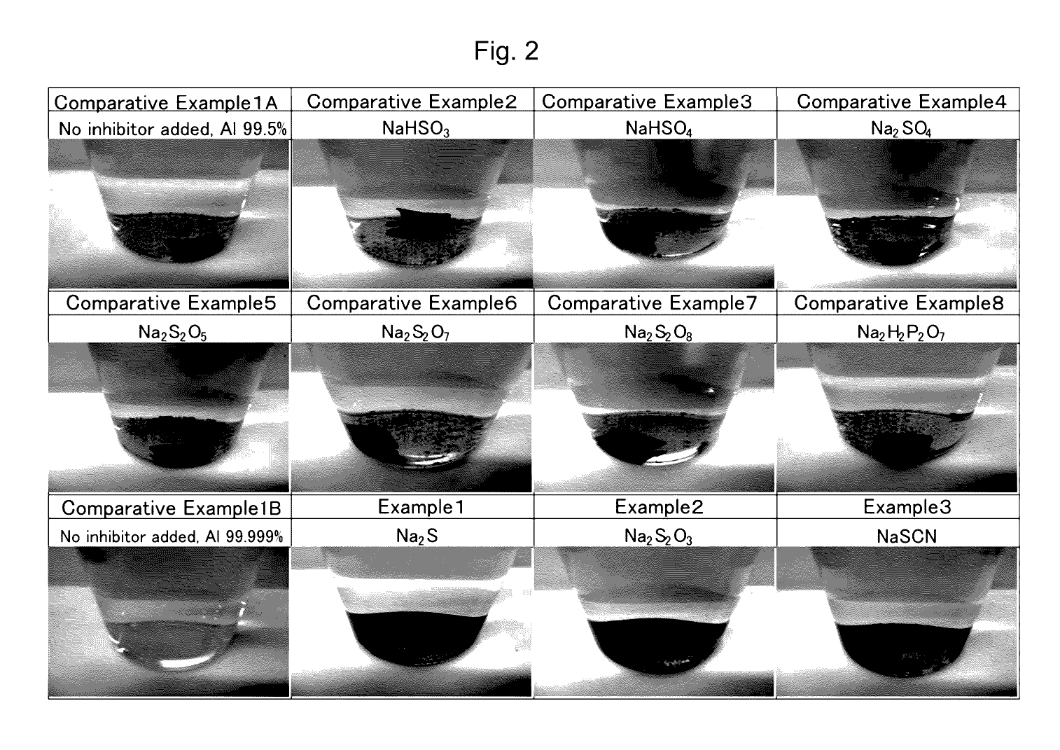

The electrolytes of Examples 1 to 3 and Comparative Examples 1 to 8 were prepared (50 mL each). They were separately put in different containers. Next, aluminum plates having a purity of 99.5% (product name: Al2N; manufactured by: Nilaco Corporation) and being cut into a size of 12 mm×12 mm×1 mm (about 0.4 g) were prepared. The surfaces of the aluminum plates were wiped with acetone. Then, the aluminum plates were separately put in the containers. A paper was placed on the top of each container, and each container was loosely capped. Thereby, hydrogen was prevented from remaining in the containers, and natural volatilization of the electrolytes was inhibited. Then, each container was put in a thermostatic bath, kept at 25° C., and allowed to stand until the generation of bubbles inside the containers finished. Images of the appearance of the inside of each container after the bubble generation finished, are shown in FIG. 2. In FIG. 2, Comparative Example 1A is the observation of an example in which the electrolyte of Comparative Example 1 and the aluminum plate having a purity of 99.5% were used.

Also in FIG. 2, Comparative Example 1B is the observation of an example in which the electrolyte of Comparative Example 1 was used, and an aluminum plate having a purity of 99.999% (product name: Al5N; manufactured by: Nilaco Corporation) was cut into the same size as above and treated in the same manner as above.

As shown in FIG. 2, in Comparative Examples 1A and 2 to 8, it is clear that a discharge product is formed in the form of large lumps, which reflect the form of the original aluminum plate.

Meanwhile, in Examples 1 to 3, it is clear that a discharge product is refined and in the form of powder.

In Comparative Example 1B, it is clear that the aluminum plate is absolutely dissolved and does not remain in the electrolyte. The reason is considered as follows: since the aluminum purity was as high as 99.999%, less impurities were produced and did not lead to the deposition and coarsening of the discharge product.

The reason why the discharge product is refined in Examples 1 to 3, is considered as follows.

First, by energy dispersive X-ray analysis (EDX), it is clear that the ratio of iron contained in the lumps of the coarsened discharge product is larger than the ratio of iron contained as one of the impurities in the early aluminum plate. Accordingly, it is considered that the iron contained in the aluminum metal as one of the impurities, is highly involved in the coarsening of the discharge product. Also, it is known that the coarsening inhibitors used in Examples 1 to 3 form a complex with iron. Also, as shown in FIG. 2, unlike Comparative Example 1B, the discharge product itself is present in Examples 1 to 3. Therefore, it is considered that the coarsening inhibitors are not involved in complex formation with the aluminum which is the main element of the anode metal.

Because of the above reasons, it is considered that due to the coarsening inhibitor contained in the electrolyte, the elution of the iron was promoted, and due to the effect of inhibiting the coarsening of the discharge product, which is exerted by the stabilization of dissolved iron ions, the refinement as shown in FIG. 2 was caused.

Even in the case of using a magnesium metal in electrodes, it is considered that the coarsening inhibitor is not involved in complex formation with the magnesium, since magnesium is a metal that is, like aluminum, electrochemically baser than iron.

### [Confirmation of Influence of Refining of Discharge Product]

### (Preparation of Electrodes)

As a working electrode, an aluminum plate having a purity of 99.5% (product name: Al2N; manufactured by: Nilaco Corporation) and being cut into a size of 25 mm×25 mm×1 mm was prepared. The surface of the aluminum plate was wiped with acetone. Then, the aluminum plate was sandwiched between nickel meshes (product name: 20 mesh; manufactured by Nilaco Corporation) and the edges of the nickel meshes were welded to each other. A nickel ribbon (manufactured by Nilaco Corporation) was welded thereto and used as a current collection wiring.

As a counter electrode, a nickel mesh (product name: 200 mesh; manufactured by: Nilaco Corporation) cut into a size of 30 mm×30 mm×1 mm, was prepared. A nickel ribbon was welded to the nickel mesh and used as a current collection wiring.

As a reference electrode, an Hg/HgO electrode was prepared.

### (Production of Evaluation Cells)

### (1) Evaluation Cell 1

As an electrolyte, the electrolyte of Example 2 (55 mL) was prepared.

A cell container (volume 60 mL) was prepared. In the cell container, the working electrode, the counter electrode and the reference electrode were placed. The electrolyte (55 mL) was put in the cell container. The cell container was capped to prevent volatilization, thereby producing the evaluation cell 1. The production of the evaluation cell 1 was carried out within 10 minutes.

### (2) Evaluation Cell 2

The evaluation cell 2 was produced in the same manner as the above “(1) Evaluation cell 1”, except that the electrolyte of Comparative Example 1 (55 mL) was prepared as an electrolyte and put in the cell container.

### (Discharge Test)

The discharge test was carried out using the evaluation cells 1 and 2. In particular, the working and counter electrodes of each evaluation cell were connected to a potentiostat/galvanostat (product name: VMP3; manufactured by: Biologic). The discharge test was carried out under the conditions of an ambient temperature of 25° C. and 400 mA.

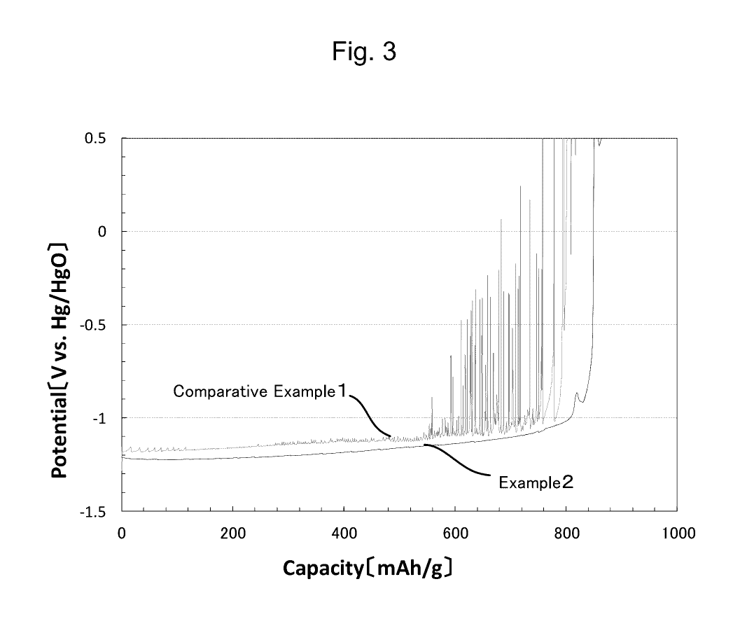

The results of the discharge test are shown in FIG. 3. FIG. 3 shows the constant current discharge curve of the evaluation cell 1 using the electrolyte obtained in Example 2, in which Na₂S₂O₃ is used as the coarsening inhibitor, and the constant current discharge curve of the evaluation cell 2 using the electrolyte obtained in Comparative Example 1, to which any coarsening agent is not added. The potential in FIG. 3 is based on the potential of the Hg/HgO reference electrode. Accordingly, hereinafter, potential will be shown on the basis of Hg/HgO.

As is clear from FIG. 3, in Comparative Example 1, noise occurs often at and later than 500 mAh/g; meanwhile, in Example 2, no noise occurs at all.

It is considered that the cause for the noise generation in Comparative Example 1 is the influence of the discharge product produced between the Ni20 mesh and the aluminum plate, which were used for current collection in the working electrode. This is because the noise as shown in FIG. 3 was not generated in the case where, as a preliminary test, the discharge test was carried out using the electrolyte of Comparative Example 1 and by connecting the wiring directly to the aluminum electrode, without the use of Ni20 mesh as the current collector of the working electrode (not shown).

Due to the above reasons, the following was confirmed: the coarsening of the discharge product is inhibited by the coarse inhibitor contained in the electrolyte and, as the result, the removal of the discharge product from reaction sites (areas around the current collectors, the surfaces of the electrodes, etc.) is easy.

### [Evaluation of Self-Discharge Inhibition]

### (Preparation of Electrodes)

A working electrode, a counter electrode and a reference electrode were prepared in the same manner as described above under “(Preparation of electrodes)” in “[Confirmation of influence of refining of discharge product]”.

### (Production of Evaluation Cells)

As electrolytes, the electrolytes of Examples 1 to 3 and Comparative Examples 1 to 7 were prepared (50 mL each).

Ten cell containers were prepared (the number of the cell containers is equal to the total number of the electrolytes of Examples 1 to 3 and Comparative Examples 1 to 7). In each cell container (volume 60 mL), the working electrode, the counter electrode and the reference electrode were placed. The electrolytes (50 mL each) were separately put in the cell containers. The cell containers were capped to prevent volatilization, thereby preparing evaluation cells. The production of the evaluation cells was carried out within 10 minutes.

### (Measurement of Open-Circuit Potential Holding Time)

For each of the evaluation cells using the electrolytes of Examples 1 to 3 and Comparative Examples 1 to 7, the open-circuit potential (OCV) holding time of the aluminum electrode (working electrode) was measured. In particular, the working and counter electrodes of each evaluation cell were connected to a potentiostat/galvanostat (product name: VMP3; manufactured by: Biologic); an open circuit was created at an ambient temperature of 25° C. for 30 hours; and the time for the potential of the working electrode to change from about −1.3 V (vs. Hg/HgO) at the beginning of the measurement to −0.8 V (vs. Hg/HgO) was measured.

The open-circuit potential holding time means a time during which the self-discharge reaction proceeds and the aluminum electrode is completely eluted. Accordingly, it is considered that as the open-circuit potential holding time increases, the self-discharge rate decreases, thereby inhibiting self-discharge. The results of the measurement of the open-circuit potential holding time are shown in Table 1. In Table 1, Comparative Example 1A is the result of a measurement in which the electrolyte of Comparative Example 1 was used, and the aluminum plate having a purity of 99.5% was used as the working electrode.

Also in Table 1, Comparative Example 1B is the result of a measurement in which the electrolyte of Comparative Example 1 was used, and an aluminum plate having a purity of 99.999% (product name: Al5N; manufactured by: Nilaco Corporation) was cut into the same size as above and measured in the same manner as above.

TABLE 1

| | | | Open-circuit |
|---|---|---|---|
| | Al | Coarsening | potential holding |
| | purity (%) | inhibitor | time (sec) |
| Example 1 | 99.5 | Na₂S | 30622 |
| Example 2 | 99.5 | Na₂S₂O₃ | 40945 |
| Example 3 | 99.5 | NaSCN | 52200 |
| Comparative Example 1A | 99.5 | — | 23111 |
| Comparative Example 1B | 99.999 | — | 29097 |
| Comparative Example 2 | 99.5 | NaHSO₃ | 22375 |
| Comparative Example 3 | 99.5 | NaHSO₄ | 23121 |
| Comparative Example 4 | 99.5 | Na₂SO₄ | 22808 |
| Comparative Example 5 | 99.5 | Na₂S₂O₅ | 25109 |
| Comparative Example 6 | 99.5 | Na₂S₂O₇ | 25067 |
| Comparative Example 7 | 99.5 | Na₂S₂O₈ | 25015 |

As shown in Table 1, the open-circuit potential holding times of the evaluation cells using the electrolytes of Examples 1 to 3 and Comparative Examples 1A, 1B and 2 to 7 are as follows: 30622 seconds in Example 1; 40945 seconds in Example 2; 52200 seconds in Example 3; 23111 seconds in Comparative Example 1A; 22375 seconds in Comparative Example 2; 23121 seconds in Comparative Example 3: 22808 seconds in Comparative Example 4; 25109 seconds in Comparative Example 5: 25067 seconds in Comparative Example 6; 25015 seconds in Comparative Example 7; and 29097 seconds in Comparative Example 1B.

As is clear from Table 1, the open-circuit potential holding times of Examples 1 to 3 are 1.2 to 2.3 times longer than those of Comparative Examples 1A and 2 to 7.

Due to the above reasons, it is considered that by forming a complex with the iron element which is one of the impurity elements in the aluminum metal, the coarsening inhibitor promotes the elution of the iron and contributes to the inhibition of the self-discharge of the metal-air batteries.

The open-circuit potential holding times of Examples 1 to 3 are 1.1 to 1.8 times longer than that of Comparative Example 1B. Therefore, it is clear that the open-circuit potential holding time becomes longer by the use of the electrolytes of Examples 1 to 3 and the aluminum having a purity of 99.5%, rather than the aluminum metal having a purity of 99.999%.

It will be appreciated that the above-disclosed features and functions, or alternatives thereof, may be desirably combined into different compositions, systems or methods. Also, various alternatives, modifications, variations or improvements may be subsequently made by those skilled in the art. As such, various changes may be made without departing from the spirit and scope of this disclosure.

1. An electrolyte for metal-air batteries having an anode containing at least one of aluminum and magnesium, the electrolyte comprising an aqueous solution comprising a coarsening inhibitor configured to inhibit coarsening of a discharge product, the coarsening inhibitor including a salt having at least one kind of anions selected from the group consisting of S²⁻ anions, SCN⁻ anions and S₂O₃²⁻ anions.

2. The electrolyte according to claim 1, wherein the coarsening inhibitor is at least one selected from the group consisting of Na₂S, NaSCN and Na₂S₂O₃.

3. The electrolyte according to claim 1, wherein a concentration of the coarsening inhibitor in the aqueous solution is in a range of 0.001 mol/L or more to 0.1 mol/L or less.

4. The electrolyte according to claim 1, wherein the aqueous solution is basic.

5. The electrolyte according to claim 1, wherein the aqueous solution includes an electrolyte salt.

6. The electrolyte according to claim 5, wherein the electrolyte salt is NaOH.

7. The electrolyte according to claim 5, wherein a concentration of the electrolyte salt in the aqueous solution is in a range of 0.01 mol/L or more to 20 mol/L or less.

8. A metal-air battery comprising:
an air electrode configured to receive an oxygen supply;
an anode containing at least one of aluminum and magnesium; and
an electrolyte according to claim 1, the electrolyte being in contact with the air electrode and the anode.

9. The metal-air battery according to claim 8, further comprising a separator disposed between the air electrode and the anode, the separator configured to retain the electrolyte.

10. The metal-air battery according to claim 9, wherein the separator is porous.

11. The metal-air battery according to claim 10, wherein the porosity of the separator is in a range of 30% to 90%.

12. The metal-air battery according to claim 9, wherein a thickness of the separator is in a range of 0.1 to 100 μm.

13. The metal-air battery according to claim 8, wherein a thickness of the air electrode is in a range of 2 μm to 500 μm.

14. The metal-air battery according to claim 8, wherein the aluminum is an aluminum metal containing impurities, and an element ratio of the aluminum in the aluminum metal is in a range of 50% or more to 99.99% or less.

15. The metal-air battery according to claim 8, wherein the aluminum is an aluminum alloy, and a content of the aluminum in the aluminum alloy is 50% by mass or more.

16. The metal-air battery according to claim 8, wherein the coarsening inhibitor is at least one selected from the group consisting of Na₂S, NaSCN and Na₂S₂O₃.

17. The metal-air battery according to claim 8, wherein a concentration of the coarsening inhibitor in the aqueous solution is in a range of 0.001 mol/L or more to 0.1 mol/L or less.

18. The metal-air battery according to claim 8, wherein the aqueous solution is basic.

19. The metal-air battery according to claim 8, wherein the aqueous solution includes an electrolyte salt.
